(19) United States
(12) Patent Application Publication
(10) Pub. No.: US 2007/0186494 A1
(43) Pub. Date: Aug. 16, 2007

(54) Joinery system

(75) Inventor: Michael John Hancock, Hamilton (NZ)

Correspondence Address: BROOKS KUSHMAN P.C., 1000 TOWN CENTER, TWENTY-SECOND FLOOR, SOUTHFIELD, MI, 48075, US

(73) Assignee: HPJ HOLDINGS LIMITED, Hamilton (NZ)

(21) Appl. No.: 10/598,751

(22) PCT Filed: Mar. 10, 2005
(86) PCT No.: PCT/NZ05/00045

§ 371 Date: Sep. 11, 2006

(30) Foreign Application Priority Data
Mar. 11, 2004 (NZ) 531715

(51) Int. Cl. E06B 3/32

(52) U.S. Cl. 52/204.51

(57) ABSTRACT

A joinery assembly which includes a fixed panel form (32) is adapted to receive and locate a fixed panel (33), where at least a portion of the exposed surfaces of the fixed panel form are covered by a cladding material (39). The joinery system also includes a movable panel forms (34a, 34b), each adapted to receive a movable panel such as a sliding panel (35a) and/or a hinged panel (35b) respectively, where each of the movable panels has an interior surface and an exterior surface. At least a portion of the interior surface of a movable panel received by a movable panel form is covered by the cladding material applied to the exposed surfaces of the fixed panel form.

### TECHNICAL FIELD

This invention relates to an improved joinery system.

Preferably the present invention may be employed to provide a composite material joinery system with an improved thermal performance and aesthetic appeal to consumers.

Reference throughout this specification will also be made to the joinery system provided employing aluminium in combination with either wood or polyvinyl chloride (μPVC) in its construction, but those skilled in the art should appreciate that potentially other materials may also be used if required.

### BACKGROUND ART

Joinery is used to frame and mount glazing in the windows and entrance ways of buildings.

Traditionally, wooden joinery has been employed for such purposes. Wooden joinery functions effectively to provide both an aesthetically attractive interior for a window or doorway and also performs well as a thermal insulator.

Thermal insulation is important in joinery to ensure that the temperature at the exterior of a building is not transferred into its interior.

The use of thermally insulative materials such as wood ensures that heat loss from the interior of a building is minimised in cold climates, and the interior of a building is not heated in warm climates.

It is also important to provide thermally insulating materials in joinery to ensure moisture condensate is not formed on the interior surfaces of the joinery.

If the interior faces of joinery are cooler than the ambient temperature inside a building, this can cause moisture to condense and potentially damage adjacent components in the interior of a building.

However, wooden joinery is not directly suited to mass production techniques and applications. Wood generally requires a high level of skill from a manufacturing labourer to form the required joinery shapes and also to install the resulting joinery in a building. Furthermore, the wood used, although relatively attractive in its final finished form, is also a relatively costly building material.

Aluminium joinery has been developed as an alternative to wooden joinery. Aluminium can be extruded into relatively complex profiles (or forms) in large volumes with relatively low labour costs.

Furthermore, the costs of the aluminium material is lower than that of wood, thereby resulting in a comparatively low cost joinery product.

However, there are some existing problems present with the use of aluminium joinery.

Aluminium joinery does not have the same level of aesthetic appeal to some consumers, who have a preference for the more natural or warmer appearance of wood.

Aluminium also does not function effectively as a thermal insulator, which results in heat losses to the exterior of a building in cold climates and the reverse effect in hot climates.

Furthermore, condensate will also generally form on the exposed interior surfaces of the joinery which can cause water or moisture damage to the surrounds of the window or doorway involved.

These thermal conduction problems are also aggravated in the case of sliding panel aluminium joinery.

Sliding panel joinery normally employs a fixed static panel and a sliding panel adjacent to the fixed panel.

The sliding panel can be moved laterally across a track laid in the joinery to open and close a window or doorway formed in a structure.

Sliding panel joinery can be configured so that the sliding panel, when placed in an open configuration, covers the exterior surface of the fixed panel (an exterior slider), or can alternatively cover the interior surface of the fixed panel (an interior slider).

As a consequence of providing the sliding panel track parallel and adjacent to the fixed panel, the overall width of the joinery formed is effectively double that of standard fixed panel joinery.

This in turn aggravates the thermal transfer problems normally associated with aluminium joinery, in that a significantly larger surface area of aluminium is then exposed on the interior side of the joinery to the interior of the building involved.

Some existing attempts have been developed to produce hybrid (or composite) joinery systems which harness both the thermal advantages of wooden cladding and the manufacturing and cost advantages of aluminium joinery. An example of composite joinery is Fletcher Aluminium ALTI® system marketed in New Zealand as also detailed at the internet address, www.altinz.co.nz.

However, the ALTI® joinery system also has a number of problems in its implementation.

A significant amount of wood is still required to clad the interior surfaces of the joinery.

This again requires a reasonably skilled labour force to produce the wooden cladding required and also once again results in increased labour manufacturing cost for the resulting composite joinery.

Furthermore, the amount of wood used again inflates the materials cost of the resulting joinery product.

These problems are even more significant in the ALTI® system when configured to provide sliding panel joinery as the increased exposed surface area on its interior side needs to be clad in wood, which further increases the labour and material costs.

In such instances the exposed interior face of the sliding panel provided is preferably clad with wood, as is the exposed interior face of the fixed panel.

In a number of instances it is also preferable to have a joinery system which allows the panels mounted or located to be easily installed and subsequently removed again if required. In the case of sliding panel joinery this requirement can complicate the joinery design due to the need to provide some form of rolling carriage to support and move the panel along the track provided.

A carriage or carriages can be connected to the top of the panel to suspend the panel from a track located in the head of the joinery, and to allow a carriage to run along the track provided (being a top rolling slider). Conversely the bottom edge of the panel may be seated on a carriage or carriages adapted to run along a track located within the sill section of the joiner (being a bottom rolling slider).

A carriage can complicate the removal of a sliding panel which is normally manoeuvred within the surrounding joinery and then subsequently pivoted and pulled out from the same. For example, in the case of a bottom rolling slider the panel is normally lifted upwards into a space in the head section of the joinery to a height where the bottom of an attached carriage will clear the top of the sill section of the joinery. At this stage the panel can then be pivoted slightly and subsequently removed from place.

The requirement to provide a clearance for the carriage of a slider places a design constraint on the resulting joinery assembly. An appropriate headspace needs to be provided in the head section of the joinery for bottom sliders (for example), which can limit the dimensions or forms available to the joinery designer, and can also potentially increase the manufacturing cost of the resulting joinery.

Other forms or other types of joinery do not necessarily incorporate sliding panels as movable panels. It is common to find hinged panels generally in the form of windows in other types of aluminium joinery. It is also possible to have a combination of both sliding panels and hinged panels in a single joinery installation.

In such instances the forms or profiles of the joinery are normally designed to receive and accommodate sliding panels but not necessarily hinged panels, which can in turn create problems in the mounting and also sealing of hinged panels.

Normally this problem is addressed through manufacturing and installing an adaptor intermediary frame into the joinery which in turn engages with and mounts a hinged panel. This intermediary frame adjusts the effective shape of the joinery profiles to allow the hinged panel to seal correctly with the joinery and also to pivot open or closed as required.

However, the need for an additional component and sub-frame again can increase the cost of the resulting joinery system. It is preferable to have a small number or set of extruded profiles used to form any resulting joinery system to reduce the overall cost of manufacturing involved. However, introducing a further sub-frame for hinged panels or windows increases manufacturing costs and times for these types of joinery.

An improved joinery system which addressed any or all of the above problems would be of advantage. Specifically a joinery system which could be produced at relatively low cost and which had improved thermal efficiencies and aesthetic appeal over the prior art would be an advantage. Further an improved joinery system or assembly which addressed design constraints present in the provision of rolling carriages with sliding panel joinery and the need to remove such panels would be of advantage. In addition, an improved joinery system which allowed the installation and effective operation of hinged panels within joinery primarily designed to accommodate sliding panels, without necessarily requiring a sub-framed to mount such panels would also be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention provided that joinery assembly which includes;

a fixed panel form adapted to receive and locate a fixed panel, wherein at least a portion of the exposed surfaces of said fixed panel form are covered by a cladding material, and

a movable panel form adapted to receive a movable panel, said movable panel having an interior surface and an exterior surface,

wherein at least a portion of the interior surface of a moving panel received by the moving panel form is covered by the cladding material applied to the exposed surfaces of the fixed panel form.

According to a further aspect of the present invention there is provided a joinery system as substantially described above wherein the interior surfaces of the movable panel form are covered by the cladding material applied to the exposed surfaces of a fixed panel form.

According to yet another aspect of the present invention there is provided a joinery assembly substantially as described above wherein the interior surfaces of at least the edges of a frame integrated into a movable panel are covered by the cladding material applied to the exposed surfaces of a fixed panel form.

According to another aspect of the present invention provided a joinery assembly substantially as described above wherein a movable panel received by a movable panel form includes a movable panel frame, wherein an at least one interior surface of the movable panel frame received by the movable panel form is covered by the cladding material applied to the exposed surfaces of the fixed panel form.

According to a further aspect of the present invention there is provided a joinery assembly which includes,

a fixed panel form adapted to receive and locate a fixed panel, wherein at least a portion of exposed surfaces of the fixed panel form are covered by a cladding material, and

a hinged panel form adapted to receive a hinged panel, the hinged panel having an interior surface and an exterior surface,

wherein at least a portion of the interior surface of the hinged panel received by the hinged panel form is covered by the cladding material applied to the exposed surfaces of the fixed panel form.

According to another aspect of the present invention there is provided a joinery assembly which includes,

a fixed panel form adapted to receive and locate a fixed panel, wherein at least a portion of the exposed surfaces of the fixed panel form are covered by a cladding material, and

a sliding panel form adapted to receive a sliding panel, the sliding panel having an interior surface and an exterior surface, wherein the sliding panel form defines a track along which the received sliding panel is adapted to move,

wherein at least a portion of the interior surface of a sliding panel received by the sliding panel form is covered by the cladding material applied to the exposed surfaces of the fixed panel form.

According to a further aspect of the present invention there is provided a joinery assembly substantially as described above wherein the fixed panel received and located by the fixed panel form and the sliding panel received by the sliding panel form are substantially aligned with respect to a common horizontal plane.

According to yet another aspect of the present invention there is provided a joinery assembly substantially as described above wherein the track defined by the sliding panel form extends substantially the length of the fixed panel form and parallel to the fixed panel form to allow the sliding panel to be moved into an open configuration which forms an aperture in a joinery assembly and places the sliding panel in a substantially parallel orientation to the fixed panel, said track also allowing the sliding panel to be moved into a closed configuration which juxtaposes the sliding panel to the fixed panel.

According to a further aspect of the present invention there is provided a joinery assembly substantially as described above wherein a movable panel form is substantially concealed from observation from the interior side of the joinery assembly by cladding applied to the exposed surfaces of the fixed panel form.

According to another aspect of the present invention there is provided a joinery assembly substantially as described above wherein a movable panel frame is substantially concealed from observation from the interior side of the joinery assembly by cladding applied to the exposed surfaces of the fixed panel form when the movable panel is received within a movable panel form.

The present invention is adapted to provide an improved joinery assembly which preferably can provide an improved aesthetic appeal to consumers. Furthermore, the joinery assembly provided may also exhibit improved thermal insulation characteristics when compared with other existing prior art forms of joinery.

The joinery assembly may be used to frame glazing or other types of panels within the walls, window apertures or doors of a structure or building. Preferably the present invention may be used with panels which can receive or locate at least one sheet of glass.

In preferred embodiments of the present invention the joinery assembly may be used to implement sliding panel doors or windows. Sliding panel joinery is well known in the art and generally used to frame glazing panels and allow these panels to be slid to and from open and closed configurations.

Reference in general will also be made throughout the specification to the use of the present invention with sliding panel doors or windows. However, those skilled in the art should appreciate other types of movable or moving panels may also be implemented in conjunction with the present invention and reference to the above only throughout the specification should in no way been seen as limiting.

For example, hinged panels which pivot away from a closed to an open position may be employed in conjunction with the present invention, either in isolation or alternatively in combination with sliding panels if required. Furthermore, joinery systems may be implemented using the present invention which incorporates hinged ‘hidden panels” in isolation or alternatively in combinations of both hidden sliding and hinged panels if required. Those skilled in the art should appreciate that various combinations and permutations of different forms of movable panel are well within the scope of the present invention.

Throughout the present specification the term “fixed panel form” should be understood to mean an assembly within the joinery assembly that locates, or can be adapted to receive, a fixed panel.

Throughout the present specification the term “fixed panel” should be understood to mean a substantially sheet-like material or assembly that is securely located, framed, or able to be received, into a desired position within, or by, the fixed panel form of the present invention.

Furthermore, a fixed panel should be considered to encompass a fixed panel frame if required. Such a frame can then provide support to the sheet-like material employed within the panel and also act as an interface element or mounting system for the panel.

For example, in a preferred embodiment of the present invention a fixed panel may be formed from a double glazed assembly constructed of glass sheets or any other suitable material used to provide the bulk of material employed to form a window or doorway of a building. In such instances a double glazed panel may include a frame surrounding the edges of the glazing sheets as well as any spacer components or elements fitted between the glazing sheets to space same apart.

Reference throughout this specification will now be made to a fixed panel being formed from a glazing panel. However this should not be seen to be a limitation on the present invention in any way as those skilled in the art should appreciate that other types of material may also be used within the present invention.

The fixed panel form defined in the joinery assembly can include a number of exposed surfaces which, when the joinery is installed, will face into the interior of the building or structure involved.

Normally such exposed surfaces would provide a heat transfer interface between the exterior and interior of the structure.

In preferred embodiments of the present invention the exposed surfaces of the fixed panel form may be clad with a thermally insulative material.

Cladding the surfaces with a thermal insulator provides a heat resistant barrier between the interior of a building and its exterior, thereby breaking any channel for heat transfer through the fixed panel form of the joinery assembly.

In a further preferred embodiment the exposed surfaces of the fixed panel form are covered or clad with a wooden material.

Wood provides an effective thermal insulator to prevent heat transfer through the materials used to construct the joinery assembly. Furthermore, wooden surfaces are potentially more aesthetically pleasing to consumers in a number of instances.

Preferably the bulk of material used to provide the joinery assembly (and in particular the fixed and movable panel forms) will be aluminium.

Aluminium is a relatively inexpensive material which can readily be extruded into a number of complex and useful forms, thereby making it very useful for joinery systems.

Preferably the joinery assembly may employ the aluminium forms in combination with thermally insulative cladding material to provide a composite joinery system with an improved aesthetic appeal and thermal insulative performance.

The term “sliding panel form” should be understood to mean an assembly within the joinery assembly that locates, or can be adapted to receive, a sliding panel and which is constructed to allow the sliding panel to move within the boundaries of the sliding panel form.

The term “sliding panel” should be understood to mean a substantially sheet-like material or assembly that is located, or able to be received by the sliding panel form of the present invention and which is able to be moved between a closed position and fully open position which are within the boundaries of the sliding panel form. Furthermore, the term “sliding panel” should be considered to encompass framing elements used to surround, protect or otherwise mount the entire sliding panel assembly, and may also incorporate any spacer elements used to distance two or more sheets of which form the bulk of the volume or surface area of the panel.

As discussed above, reference throughout this specification will be made in general to a moving panel and moving panel form being implemented through a sliding panel and sliding panel form. Those skilled in the art should however appreciate that equivalent hinged panel and hinged panel forms can also be used in conjunction with the present invention.

The sliding panel form receives a sliding panel but yet still allows the sliding panel to be moved relative to the installed overall joinery assembly. Such sliding panels may therefore facilitate the provision of window or doorway openings within the finished/installed joinery assembly.

In preferred embodiments of the present invention the sliding panel installed or received into the sliding panel form is constructed from a glazing panel or glazing sheet assembly.

Such glazed sliding panels are well known in joinery applications and allow sliding window assemblies to be constructed and also sliding door assemblies to be constructed where the bulk of the window or the door is formed from glass sheet materials.

Furthermore, such glazed panels can also employ double glazing techniques to provide a significant degree of thermal insulation across the glazed portion of the window or doorway provided.

Reference throughout this specification will also be made to a sliding panel being implemented as a double glazed panel. Such a panel may include a sliding panel frame which surrounds the parameter edges of the glazing, where such framing also includes glazing spacers located between the sheets of the double glazing panel to space the same apart from one another.

However, those skilled in the art should appreciate that other types of sheet like materials or assemblies may be employed to provide such panels, and reference to the above only throughout the specification should in no way be seen as limiting.

Preferably the sliding panel, once received by the sliding panel form, may define or include an interior surface and an exterior surface.

The interior surface of the sliding panel will be located or positioned so as to face the interior of the structure within which the joinery assembly is installed.

Conversely, the exterior surface of the sliding panel will be formed by the opposite surface to the interior surface and will face out into the environment that is exterior to the structure in which the joinery assembly is employed.

In a preferred embodiment of the present invention the configuration or arrangement of the fixed panel form and its associated cladding material may be constructed so that the cladding material involved also covers the perimeter (or edges) of the interior surface of the sliding panel.

In such instances, the sliding panel may be framed with aluminium material or other forms of relatively low cost materials which can be easily manufactured and installed, but which may have a high degree of thermal conductivity.

Such framing materials may be used to locate the glazing sheets provided and subsequently act as an interface with the sliding panel form.

Furthermore, the insulative cladding applied over the exposed surfaces for the fixed panel form may also be positioned or arranged so as to also cover and insulate the exposed interior surfaces of the sliding panel form.

In such embodiments the fixed panel form cladding will perform a dual insulative role by insulating both the framing material of the sliding panel and the exposed interior surfaces of the fixed panel form.

Furthermore, the fixed panel cladding can also conceal, cover or effectively hide from view the interior portions of the sliding panel form and also potentially the sliding panel frame. Hiding these components from view can provide visual and potentially pleasing results in the construction of the finalised installed joinery assembly.

In a further embodiment cladding material applied to the fixed panel form may also be adapted to conceal, cover or effectively hide from view the sliding panel frame and also portions of sheet materials employed to form the majority of the surface area of the panel. In such embodiments elements or edges of the sliding panel frame (or movable panel frame in other embodiments) may not necessarily be aligned with the surface of the cladding applied to the fixed panel form, but instead may be dropped down or recessed further into the sliding panel form. This will in turn increase the surface area of the sliding or movable panel covered and insulated by the cladding material applied to the fixed panel form in such embodiments.

In preferred embodiments of the present invention both the fixed panel and the sliding panel are substantially aligned along, or about, a common horizontal plane.

Those skilled in the art should appreciate that the ‘substantial’ alignment of these panels should be understood to encompass some degrees of variation and positioning and yet still maintain both panels at approximately the same effective height within the joinery assembly with respect to one another.

This configuration of the panel forms can locate the sliding panel at a height or horizontal position at which the framing for the sliding panel will be insulated or covered by the cladding on the fixed panel form that covers and insulates the framing on the fixed panel.

Furthermore, this configuration of the present invention can allow the alignment of at least one glazing spacer incorporated into a fixed panel with at least one glazing spacer incorporated into the movable or sliding panel.

However, as discussed above the alignment of fixed and movable or sliding panels need not necessarily be considered essential to the implementation of the present invention. For example, as discussed above, the movable or sliding panel may be configured so as to have at the very least the edges or frame of a panel fully recessed within the movable or sliding panel form, with out necessarily having to align any of the glazing spacers incorporated in either panel.

Those skilled in the art should appreciate that in such embodiments the relevant portions of the sliding or movable panel and the sliding or movable panel form will be still be covered by the cladding applied to the fixed panel form. Furthermore in some instances it may also be preferable to recess such glazing spacers deeper than normal into the receiving sliding or movable panel form involved. By receiving glazing spacers further into the surrounding form this protects a spacer from damage or degradation by long term exposure to sunlight.

In some preferred embodiments the sliding panel form also includes or defines a track along which the sliding panel is adapted to move. Preferably the track defined may extend substantially along the length or width of the joinery assembly so as to allow the sliding panel to be moved across, or along, the entire length of the joinery assembly if required.

In a further preferred embodiment the track defined in the sliding panel form may allow the sliding panel to be located in either an open configuration, or a closed configuration, or in a position or location between these opposed configurations.

For example, when placed in an open configuration, the sliding panel will form an aperture within the joinery assembly such as a doorway or opened window and will be aligned substantially parallel with the fixed panel so that the sliding panel covers (or is covered by) the fixed panel.

Conversely, when placed in its closed configuration the sliding panel may close the aperture it would normally form when open and be placed juxtaposed or orientated juxtaposed and slightly offset, across the width of the joinery assembly with respect to the fixed panel.

It should be appreciated however that when in the fully open or fully closed position the sliding panel frame can be effectively hidden from sight by the combination of the cladding of the fixed panel form and the fixed panel.

In some embodiments a sliding panel may be implemented as a bottom rolling sliding panel. In this form one or more carriages may be disposed between the bottom sill edge of the panel and a track provided in the sill area of the sliding panel form.

In such embodiments the sliding panel frame may be provided with a removable connection to carriage or carriages which run along the track and the sill of the sliding panel form. Such removable or releasable connections to a carriage will allow a carriage to be disconnected from the panel frame prior to the panel being removed from within the joinery assembly.

Allowing the carriage or carriages employed to be removed from the panel means that the effect of the overall height of the panel is reduced prior to the panel needing to be lifted and subsequently pivoted out of the joinery assembly. This in turn alleviates the design constraints present on the joinery system which require a sufficient head depth within the head sections of the sliding panel form to give appropriate clearance to the sill edge of the panel as it is removed.

This design improvement is also preferable with respect to the present invention due to the cladding material applied to the exposed surfaces of the fixed panel form also covering elements of the sliding panel and sliding panel form. This requirement in general can position the sill sections of the sliding panel frame deeper into the sill cavities of the sliding panel form thereby requiring a greater head depth to facilitate the removal of the panel. Conversely with the removal of the carriage or carriages from the sill edge of the panel this reduces the overall head depth required to facilitate the removal of the panel from the joinery assembly.

As discussed above, the provision of sliding panels in conjunction with the present invention need not be considered essential. For example, as discussed further below, hinged panels may also be implemented as the moving panel to be hidden, clad or otherwise insulated in conjunction with the present invention.

In such embodiments, the hinged panel frame may be positioned or located so as to preferably align the fixed panel form cladding to cover all sections and components of the hinged panel frame. In the case of double glazed hinged panels, the panel may be raised or lowered as required to align the top edges of the panel frame and a glazing spacer between the glazing sheets with the surface of a cladding applied to the fixed panel form.

This overall result may be achieved preferably through minor modifications to the dimensions and shape of a sliding panel form to create a hinged panel form. The design of both these forms can be modified so as to allow either a hinged or a sliding panel to be mounted and used. In the case of hinged panels, the depth of the top surface panel's sill can be increase to provide additional clearance for the bottom of hinged panel as it is pivoted open. Corresponding modifications may also be made to the location of any tracks or rails provided for top rolling sliding panel carriages in the head of the form to again allow further room for the pivoting panel as it is opened or closed.

In a further preferred embodiment, a hinged panel and its associated frame may be directly connected to a hinged panel form via a hinge mechanism. This configuration of the present invention eliminates the need or requirement for an intermediary or adapting sub-frame to be located between the hinged panel form and the associated panel. This direct connection may be achieved through design changes in a standard sliding panel form which increase the clearances required for a hinged panel to move and open and close effectively and yet will still allow essentially the same form to be employed to mount either a sliding or a hinged panel.

From the aforegoing description it can clearly be seen that the present invention has many advantages over the prior art systerns, both functionally and aesthetically.

One significant advantage is that when closed in preferred embodiments the present invention appears to implement a two-panel wooden window. This is not only aesthetically pleasing to most people but more importantly, it can have a much lower thermal dissipation rate than if the aluminium framework were exposed.

Another advantage is that due to the sliding panel frame being hidden by the fixed panel form cladding, the frame involved does not need to be separately clad. This lowers the cost of manufacture and also reduces the amount of cladding visible when viewing the joinery assembly required.

In addition, the present invention can be adapted to provide a releasable bottom rolling carriage connection for bottom rolling sliding panels. Such carriages may be provided with a removal connection to the bottom edge of a bottom rolling carriage, thereby releasing the size or dimensions of a headspace required in the head of the joinery profile to facilitate the removal of such panels.

The present invention may also be adapted to provide the thermal and aesthetic advantages discussed above with either sliding or hinged panels, or any combination of both sliding and hinged panels together in the same joinery assembly. This facility provides a joinery designer with a significant degree of freedom with respect to how a particular joinery product is designed, implemented and used.

### BRIEF DESCRIPTION OF DRAWINGS

Further aspects of the present invention will become apparent from the following description which is given by way of example only and with reference to the accompanying drawings in which:

FIG. 1 shows a side cross section view of an existing prior art composite clad joinery system; and

FIGS. 2 & 3 show side cross section views of a bottom rolling sliding panel door joinery assembly as implemented in conjunction with a preferred embodiment of the present invention, and

FIGS. 4 & 5 show side cross section views of a top rolling sliding panel joinery assembly as implemented in conjunction with an alternative embodiment of the present invention discussed with respect to FIGS. 2 and 3, and

FIG. 6 shows a side cross section view of a joinery assembly implemented in accordance with yet another embodiment of the present invention which provides both hinged and sliding panels in addition to a fixed panel in a joinery assembly.

FIG. 7a & 7b show side cross section views of a joinery assembly as implemented in accordance with a further embodiment which provides a fixed and a hinged panel, with the hinge panel being provided through an alternative design latch shown with respect to FIG. 6.

### BEST MODES FOR CARRYING OUT THE INVENTION

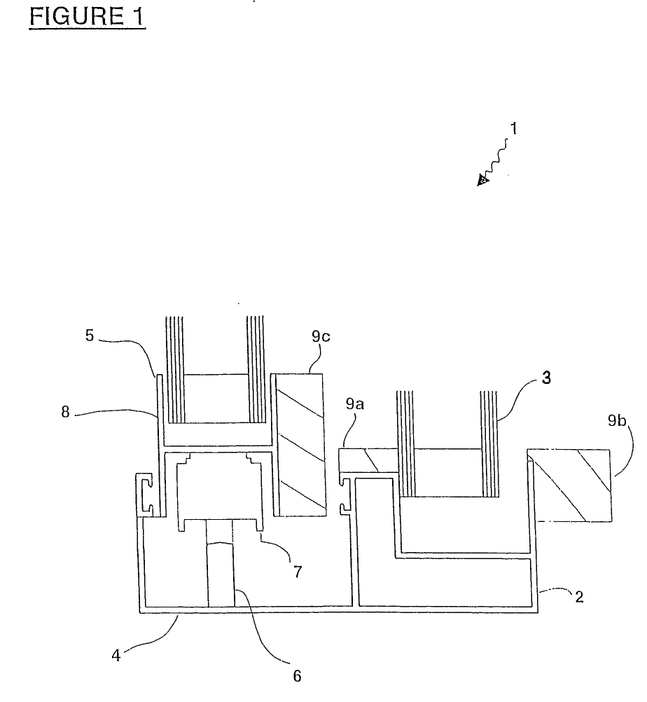

FIG. 1 shows a side cross section view of an existing prior art composite clad joinery system.

The bottom or sill sections of the joinery assembly (1) shown illustrate a bottom rolling sliding panel which is located on the exterior side of the joinery.

The joinery (1) provides a fixed panel form (2) which locates a fixed panel (3). Also provided is a sliding panel form (4) which locates a sliding panel (5). The sliding panel (5) runs along a single monorail track (6) in the sill of the sliding panel form (4) using a carriage (7) linked to the underside of the panel framing components (8).

The joinery assembly (1) also includes various sections of cladding material (9) installed to improve the thermal insulative properties of the resulting joinery. Cladding components (9a), (9b) are applied to the exposed surfaces of the fixed panel form. Conversely, an additional cladding component (9c) is needed to cover and insulate further exposed surfaces of the sliding panel (5).

As can be seen from FIG. 1, the cladding components (9) are orientated towards the interior side of the structure within which the joinery is assembled. This orientation covers all exposed metallic or aluminium joinery surfaces, thereby reducing heat transmission across or over these surfaces. The inclusion of such cladding material increases the overall cost of the resulting joinery system and complicates its manufacture.

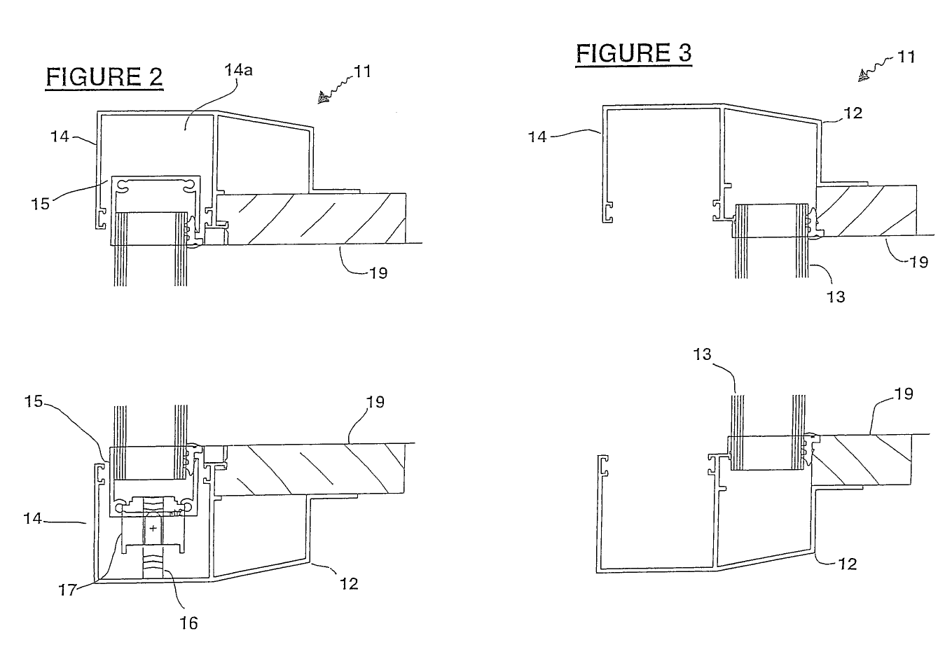

FIGS. 2 and 3 show side cross section views of a bottom rolling sliding panel door joinery assembly as implemented in conjunction with a preferred embodiment of the present invention.

FIGS. 2 and 3 show cross section side view of the same joinery assembly (11) at different positions along its length. FIG. 2 shows the section of the joinery closed or filled with a bottom rolling sliding panel (15), whereas FIG. 3 shows the sections of the joinery filled by a fixed panel (13).

The joinery assembly (11) includes a fixed panel form (12) adapted to receive and locate the fixed panel (13).

The joinery assembly (11) also includes a movable panel form, shown in this embodiment as a sliding panel form (14). The sliding panel form (14) is adapted to receive and locate a movable panel, shown in this embodiment as the sliding panel (15).

The sliding panel (15) is implemented as a bottom rolling sliding panel which travels along a track (16) in the sill of the sliding panel form (14) through use of a bottom rolling carriage (17).

The bottom rolling carriage (17) is attached to the bottom section of the sliding panel (15) through a removable connection. As can be seen from a comparison with the joinery assembly shown in FIG. 1, the bottom sections of the sliding panel frame have been substantially modified and reduced in size and extent. These modifications, when combined with the ability to remove the carriage (16), reduce the size of the headspace or gap (14a) required in the sliding panel form head to lift and subsequently remove the sliding panel from the joinery assembly (11).

Sections of cladding material (19) are also applied over the exposed surfaces of the fixed panel form (12). As cladding material (19) can be formed into different components which meet at a central mullion (not shown) of the joinery assembly or alternatively can be formed from a single integral cladding component of the appropriate form or dimensions.

As can be seen from FIG. 2, the position and alignment of the sliding panel (15) is such that all portions of the sliding panel frame (including the glazing spacer between the two sheets of glazing panel) are hidden or covered by the cladding (19) applied to the fixed panel form. This single section of cladding applied to the fixed panel form will in the embodiment shown cover both the sliding panel form and the sliding panel framing elements from view from the interior side of the building on which the joinery assembly (11) is installed.

This provides an improved aesthetic appeal for the resulting joinery and also limits its thermal conductive characteristics. The single section of cladding (19) applied insulates both the fixed and sliding panels in addition to both the fixed and sliding panel forms.

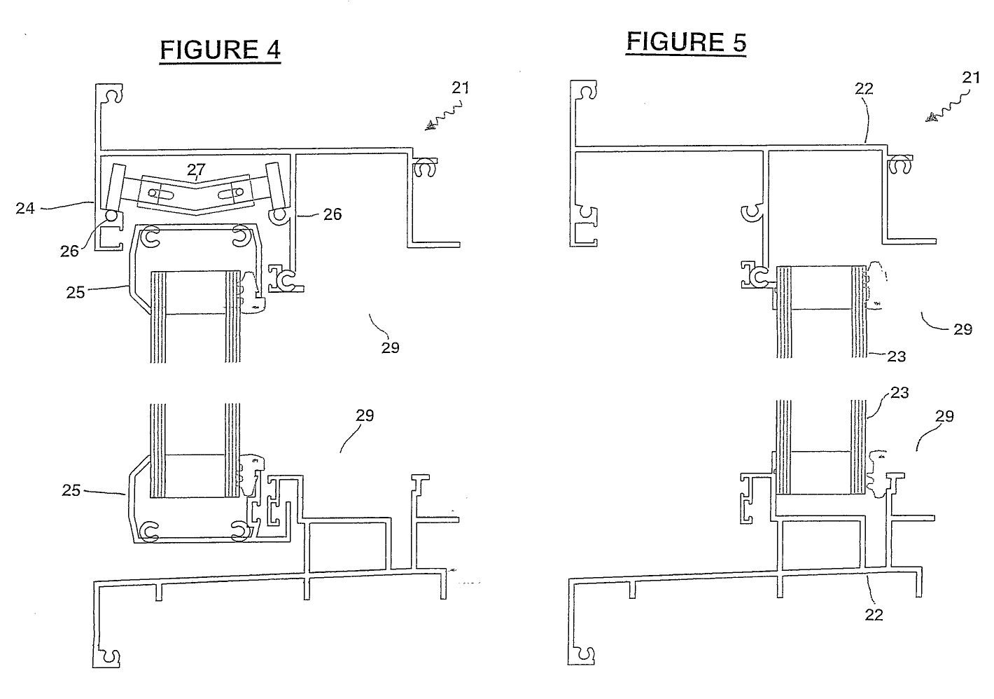

FIG. 4 shows a side cross section view of a top rolling sliding panel joinery assembly as implemented in conjunction with an alternative embodiment of the present invention discussed with respect to FIGS. 2 and 3.

FIG. 4 illustrates how the same approach discussed with respect to FIGS. 2 and 3 for a bottom rolling panel may be used with respect to a top rolling panel (25) located by a sliding panel form (24). Again, a fixed panel (23) is provided and also located by a fixed panel form (22). The same fixed panel and associated fixed panel form is covered or clad by a series of cladding components (29).

The top rolling panel (25) is adapted to move along a pair of rails forming a track (26) in the upper or head sections of the joinery assembly (21) provided. The top rolling panel (25) moves along the track (26) via a carriage (27) linked to the upper sections of the panel.

As can be seen from FIG. 4, again the same cladding components (29) used to cover and insulate the fixed panel form can in turn also cover the sliding panel form (24) and the framing components of the sliding panel (25). Each of the glazing spacers integrated within the top rolling sliding panel (25) are substantially aligned with the surfaces of the cladding material (29).

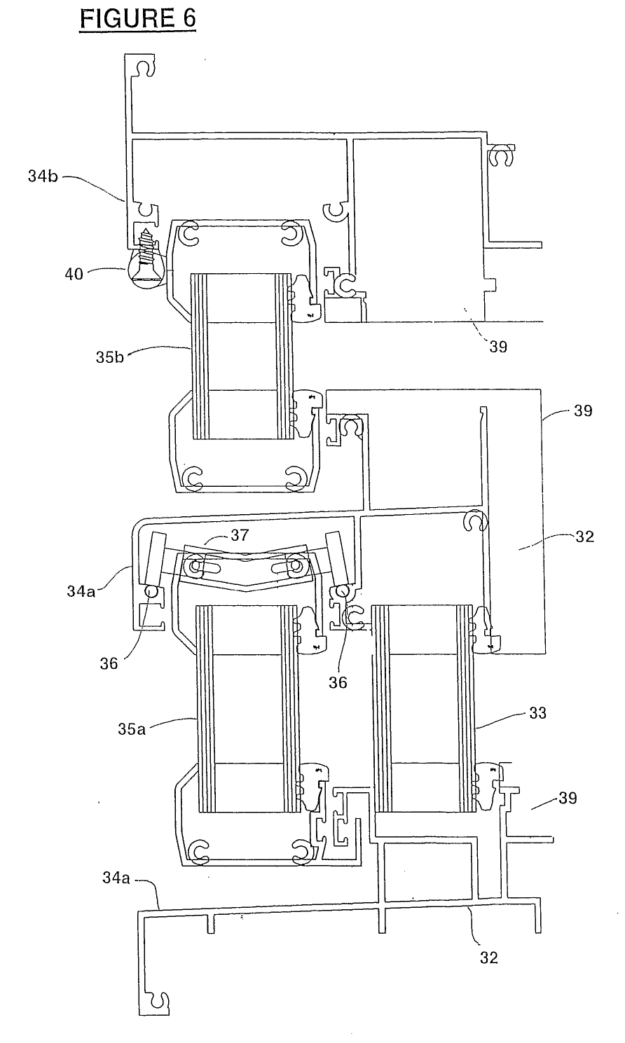

FIG. 6 shows a side cross section view of a joinery assembly implemented in accordance with yet another embodiment of the present invention which provides both hinged and sliding panels in addition to a fixed panel in a joinery assembly.

The joinery assembly shown again includes a fixed panel (33) mounted and located by a fixed panel form (32). The fixed panel is also clad and insulated by a series of cladding components (39).

However, in the embodiment shown with respect to FIG. 6, two movable panels (35a, 35b) are provided. Panel (35a) is implemented as a “top rolling” sliding panel which is adapted to move along a pair of rails (36) in a horizontal structural member or transom section of the sliding panel form (34a) via a carriage (37).

The joinery system includes a further movable panel, implemented in the embodiment shown by a hinged panel (35b). This hinged panel is located in place through a hinged panel form (34b). The hinged panel form (34b) is the same section shown in FIG. 4 (24). Essentially the same form may be reused to provide for a hinged panel thereby reducing the number of parts and extrusions required to provide an aluminium system which also includes either sliding or hinged panels.

The hinged panel (35b) is directly connected to the hinged panel form (34b) by a hinge (40). The height or position at which the hinge (40) connects to the hinged panel (35b) is again such that the glazing spacers of the hinged panel (35b) are aligned with the top surfaces of the cladding material (39) to effectively hide the panel framing and the associated hinged panel form (34b). The hinged panel (35b) is also covered or clad by the cladding materials (39) applied over the fixed panel form (32).

As can also be seen from FIG. 6, the hinged panel (35b) is located within the hinged panel form (34b) at a position which allows for sufficient clearance of the edges of the panel as it pivots and swings out away from the joinery assembly provided.

This configuration of the hinged panel form (34b) eliminates the need for an intermediary subframe to be located between the form and the panel which is to be mounted. This particular arrangement of the hinged panel form allows the hinged panel to be directly connected to the form as shown using the hinge (40).

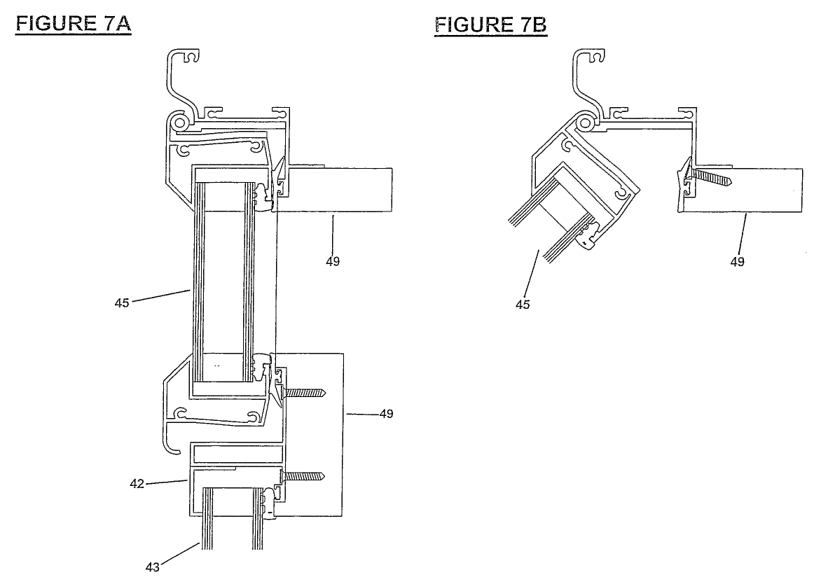

FIG. 7a and 7b show side cross section views of a joinery assembly as implemented in accordance with a further embodiment which provides a fixed and a hinged panel, with the hinge panel being provided through an alternative design latch shown with respect to FIG. 6.

FIG. 7a shows the hinged panel when in a closed position, whereas FIG. 7b shows a portion of the assembly shown with respect to FIG. 7a with the hinge panel in an open position.

An alternative hinged panel frame and form design is employed as shown with respect to FIGS. 7a and 7b to that discussed and illustrated with respect to FIG. 6. In particular the use of a single fixed panel with a single hinged panel allows the overall width of the joinery assembly provided to be effectively halved when compared with the assembly shown with respect to FIG. 6. This in turn provides a more compact and also cost effective joinery design when a single fixed and hinged panel is to be provided.

In many other respects the designs disclosed are comparatively similar, with the assembly of FIGS. 7a and 7b including cladding (49) on the interior side joinery which covers the frame and form of the hinged panel (45). The same cladding (49) is again used to cover the fixed panel form (42) and the edges of the fixed panel (43).

Aspects of the present invention have been described by way of example only and it should be appreciated that modifications and additions may be made thereto without departing from the scope thereof.

What we claim is:

1. A joinery assembly which includes;
a fixed panel form adapted to receive and locate a fixed panel, wherein at least a portion of the exposed surfaces of said fixed panel form are covered by a cladding material, and
a movable panel form adapted to receive a movable panel, said movable panel having an interior surface and an exterior surface,
wherein at least a portion of the interior surface of a movable panel received by the movable panel form is covered by the cladding material applied to the exposed surfaces of the fixed panel form.

2. A joinery assembly as claimed in claim 1, wherein the panels received include at least one sheet of glass.

3. A joinery assembly as claimed in claim 1 or 2, wherein the joinery assembly is formed at least in part from aluminum.

4. A joinery assembly as claimed in any previous claim, wherein the fixed panel form includes a plurality of exposed surfaces which face the interior of a structure when the joinery assembly is installed into said structure.

5. A joinery assembly as claimed in any previous claim, wherein the exposed surfaces of the fixed panel form are clad with a thermally insulative material.

6. A joinery assembly as claimed in claim 5, wherein the thermally insulated cladding applied to the fixed panel form is a wooden material.

7. A joinery assembly as claimed in any previous claim, wherein the fixed panel received by the fixed panel form and the sliding panel received by the sliding panel form are substantially aligned with respect to a common horizontal plane.

8. The joinery assembly as claimed in any of one of claims 2 to 7, wherein each of the fixed panel and sliding panels include at least one glazing spacer, wherein a glazing spacer incorporated into the fixed panel is aligned with a glazing spacer incorporated into the movable panel.

9. The joinery assembly as claimed in any previous claim, wherein the interior surfaces of the movable panel form are covered by the cladding material applied to the exposed surfaces of the fixed panel form.

10. The joinery assembly as claimed in any previous claim, wherein the interior surfaces of at least the edges of a frame integrated into a movable panel are covered by the cladding material applied to the exposed surfaces of the fixed panel form.

11. The joinery assembly as claimed in claim 10, wherein at least one interior surface of the movable panel frame is covered by the cladding material applied to the exposed surfaces of the fixed panel form.

12. The joinery assembly as claimed in claim 10 or 11, wherein the movable panel frame is concealed from observation from the interior side of the joinery assembly by the cladding material applied to the exposed surfaces of the fixed panel form.

13. The joinery assembly as claimed in any previous claim, wherein the movable panel is formed as a hinged panel.

14. The joinery assembly as claimed in any one of claims 1 to 13, wherein the movable panel is formed as a sliding panel.

15. The joinery assembly as claimed in claim 14, wherein the movable panel form defines a track which extends along the length of the fixed panel form and runs parallel to the fixed panel form.

16. The joinery assembly as claimed in claim 14 or 15, wherein the movable panel is implemented as a bottom rolling sliding panel.

17. The joinery assembly as claimed in claim 16, wherein the bottom rolling sliding panel provided includes a removable connection to a carriage adapted to run the length of the track formed within the movable panel form.

18. A joinery assembly which includes,
a fixed panel form adapted to receive and locate a fixed panel, wherein at least a portion of the exposed surfaces of the fixed panel form are covered by a cladding material, and
a sliding panel form adapted to receive a sliding panel, the sliding panel having an interior surface and an exterior surface, wherein the sliding panel form defines a track along which the received sliding panel is adapted to move,
wherein at least a portion of the interior surface of a sliding panel received by the sliding panel form is covered by the cladding material applied to the exposed surfaces of the fixed panel form.

19. A joinery assembly as claimed in claim 18, wherein the fixed panel received and located by the fixed panel form and the sliding panel received by the sliding panel form are substantially aligned with respect to a common horizontal plane.

20. A joinery assembly which includes,
a fixed panel form adapted to receive and locate a fixed panel, wherein at least a portion of exposed surfaces of the fixed panel form are covered by a cladding material, and
a hinged panel form adapted to receive a hinged panel, the hinged panel having an interior surface and an exterior surface,
wherein at least a portion of the interior surface of the hinged panel received by the hinged panel form is covered by the cladding material applied to the exposed surfaces of the fixed panel form.

21. The joinery assembly as claimed in claim 20, wherein the hinged panel includes a frame, said frame being aligned with the fixed panel form cladding to cover said hinged panel frame.

22. The joinery assembly as claimed in claim 21, wherein the hinged panel frame is directly connected to the hinged panel form by a hinge mechanism.

23. The joinery assembly as claimed in any one of claims 20 to 22, wherein hinged panel includes at least one glazing spacer with the hinged panel positioned so as to align said at least one glazing spacer with the surface of a cladding material applied to an exposed surface of the fixed panel form.

24. A method of manufacturing a joinery assembly substantially as herein described with reference to and as illustrated by the accompanying FIGS. 2 to 6 and/or examples.

25. A joinery assembly substantially as herein described with reference to and as illustrated by the accompanying FIGS. 2 to 6 and/or examples.
